(19) United States
(12) Patent Application Publication
(10) Pub. No.: US 2025/0050503 A1
(43) Pub. Date: Feb. 13, 2025

(54) CONTROL SYSTEM AND METHOD FOR GUIDING CLASSIFIED STORAGE AND FEEDING/DISCHARGING TAKEOUT AND PLACEMENT OF LOCK PINS

(71) Applicant: SHANGHAI ZHENHUA HEAVY INDUSTRIES CO., LTD, Shanghai (CN)

(72) Inventors: Le CAO, Shanghai (CN); Chaoqun ZHOU, Shanghai (CN); Feng YUAN, Shanghai (CN); Yujie ZHANG, Shanghai (CN); Jinqian CHEN, Shanghai (CN); Yongxin ZHAO, Shanghai (CN)

(21) Appl. No.: 18/721,202

(22) PCT Filed: Sep. 14, 2022
(86) PCT No.: PCT/CN2022/118662

§ 371 Date: Jun. 18, 2024

(30) Foreign Application Priority Data
Dec. 31, 2021 (CN) 202111658588.6

(51) Int. Cl. B25J 9/16; B65G 47/74; G05B 19/05

(52) U.S. Cl. CPC B25J 9/1687; B25J 9/1697; B65G 47/74; G05B 19/054; G05B 2219/13144

(57) ABSTRACT

Disclosed in the present invention are a control system and method for guiding classified storage and feeding/discharging takeout and placement of lock pins. The control system for guiding classified storage and feeding/discharging takeout and placement of lock pins comprises a terminal operation system, a guide system, a robot system, a feeding and discharging device, a transportation unit, and a stacking storage unit. The terminal operation system acquires terminal operation information in real time, and transmits, to the guide system, information of containers needing to be unloaded and loaded and information of corresponding lock pins. The guide system performs guide processing on a source and a destination of the lock pins according to the information transmitted by the terminal operation system, and controls the robot system, the feeding and discharging device, the transportation unit, and the stacking storage unit to perform operations of disassembling and assembling, classified storage, and feeding/discharging takeout and placement on the lock pins. According to the present invention, by means of double confirmation of the type and number of the lock pins, the destination of the disassembled lock pins and the source of the assembled lock pins are adjusted in real time to achieve rapid response and accurate control, thereby increasing the automation rate of a container lock pin disassembling and assembling platform.

### TECHNICAL FIELD

The present invention relates to the field of disassembly and assembly of container lock pins, and in particular relates to a control system and method for guiding classified storage and feeding/discharging takeout and placement of lock pins.

### BACKGROUND OF THE INVENTION

At present, lock pins of containers are disassembled and assembled always relying on the traditional manual disassembly and assembly mode. This mode needs to consume a lot of labor cost and time cost, and has large labor intensity, which seriously hinders the development of automation technologies. In addition, it is one of the key technologies to improve the automation efficiency of a container lock pin disassembling and assembling platform, in order to collect and classify various disassembled lock pins, and to correctly and automatically supplement the lock pins of the system in an installation link. In addition, a control system also needs to interact information with a TOS system at any time, and at the same time calculate and predict the changes in quantity and types of pre-disassembled and pre-assembled containers, improve an automation rate of a lock assembling link, and accurately control a lock head emptying state in a stacked storage unit at the end of a platform operation, thereby avoiding the situations of ship locking, etc.

However, a general control mode in the prior art is difficult to deal with a destination of a lock head in time and reduce a participation rate of manual feeding. When the container lock pin disassembling and assembling platform starts to operate, if an operation mode is often switched between a disassembled state and an assembled state, a good guiding strategy for lock pins in the operation procedure is required to increase the automation rate of the platform whatever the dissembled lock is directly thrown away from feeding and discharging, or stored first for later locking, or how many lock heads of the corresponding type and quantity are supplemented through feeding and discharging.

In view of the above situations, it is urgent to develop a control system and method for guiding classified storage and feeding/discharging takeout and placement of lock pins, which can adjust the destination of disassembling the lock head and the source of assembling the lock head in real time, and achieve rapid response and accurate control, thereby increasing an automation rate of the container lock pin disassembling and assembling platform.

### BRIEF SUMMARY OF THE INVENTION

In view of the above defects existing in the prior art, an object of the present invention is to provide a control system and method for guiding classified storage and feeding/discharging takeout and placement of lock pins. Through double confirmation for the types and the quantity of the lock pins, a destination of disassembling the lock pins and a source of assembling the lock pins are adjusted in real time, and rapid response and accurate control are achieved, thereby increasing an automation rate of a container lock pin disassembling and assembling platform.

In order to achieve the above object, the technical scheme adopted in the present invention is as follows:

The first aspect of the present invention provides a control system for guiding classified storage and feeding/discharging takeout and placement of lock pins, comprising:
a terminal operating system, a guiding system, a robot system, a feeding/discharging device, a transportation unit, and a stacked storage unit, wherein
the terminal operating system is configured to acquire terminal operation information in real time and transmit information of containers that need to be unloaded and loaded and corresponding lock pin information to the guiding system; and
the guiding system is configured to guide a source and a destination of lock pins according to the information transmitted by the terminal operating system, and control the robot system, the feeding/discharging device, the transportation unit and the stacked storage unit to perform operations for disassembly and assembly, classified storage and feeding/discharging takeout and placement of the lock pins.

Preferably, the guiding system comprises a PC host and a PLC controller; the PC host is configured to receive the information transmitted by the terminal operating system, perform classified calculation on the lock pins that need to be disassembled and assembled, then make a guiding judgment on the source of assembling the lock pins and the destination of disassembling the lock pins, and transmit a guiding judgment result to the PLC controller; and the PLC controller is configured to control the robot system to disassemble and assemble the lock pins according to the information transmitted by the PC host, and transport the disassembled lock pins to the stacked storage unit by using the transportation unit for classified storage, or control the feeding/discharging device to perform a feeding/discharging takeout and placement operation for the lock pins.

Preferably, the transportation unit comprises a transportation device and a servo crane; the transportation device is configured to transport the lock pins disassembled by the robot system to an exchange area of the stacked storage unit; and the servo crane is configured to perform classified storage on the switched lock pins or perform the feeding/discharging takeout and placement operation through the feeding/discharging device.

Preferably, the control system for guiding classified storage and feeding/discharging takeout and placement of lock pins further comprises a visual recognition device and an HMI touch screen; the visual recognition device is installed on an end shaft of the robot system to perform photo recognition on the lock pins; the HMI touch screen is configured to perform a manual operation; and when lock pin information recognized by the visual recognition device is inconsistent with lock pin information provided by the terminal operating system, a lock pin type is manually confirmed through the HMI touch screen, and the HMI touch screen feeds the result back to the terminal operating system and the guiding system.

Preferably, the visual recognition device is a binocular vision camera.

The second aspect of the present invention provides a control method for guiding classified storage and feeding/discharging takeout and placement of lock pins, which adopts the control system as the first aspect and comprises the following steps:
starting a lock pin disassembling and assembling platform, and then establishing a communication between the terminal operating system and the guiding system, wherein the terminal operating system is configured to transmit information of containers that need to be unloaded and loaded in the current operation and corresponding lock pin information to the guiding system; and
performing classified calculation on the pin locks by the guiding system, judging a source and a destination of each type of lock pins and making a guiding process, wherein the guiding system is configured to control the robot system, the feeding/discharging device, the transportation unit and the stacked storage unit to perform operations for disassembly and assembly, classified storage and feeding/discharging takeout and placement of the lock pins.

Preferably, a classified calculation procedure performed by the guiding system for the pin locks is as follows: the PC host classifies the lock pins according to the information transmitted by the terminal operating system, counts the quantity of each type of lock pins that need to be disassembled and assembled, then perform compared calculation on the quantity of each type of lock pins that need to be disassembled and assembled and a dynamic quantity of said type of lock pins stored in the stacked storage unit, and finally makes a guiding judgment on the source of assembling each type of lock pins and the destination of disassembling the lock pins, and transmit a guiding judgment result to the PLC controller.

Preferably, the guiding procedure is as follows:
a lock pin disassembling and assembling operation, wherein the PLC controller controls the robot system to disassemble and assemble the lock pins that need to be disassembled and assembled, and transfers the disassembled lock pins to the transportation device;
classified storage of the lock pins, wherein the PLC controller transfers the disassembled lock pins to an exchange area of the stacked storage unit by using the transportation device, and controls the servo crane to perform classified storage on the lock pins in the exchange area; and
a feeding/discharging takeout and placement operation, wherein the PLC controller guides the servo crane to transfer the disassembled lock pins or the lock pins in the exchange area to the feeding/discharging device for the feeding/discharging takeout and placement operation.

Preferably, the guiding process further comprises recognizing types of the lock pins;
a procedure of recognizing the types of the lock pins is as follows: in the process of the lock pin disassembling and assembling operation, the PLC controller controls the visual recognition device on the robot system to perform photo recognition on the lock pins; when the type of the lock pins recognized by the visual recognition device is consistent with lock pin information transmitted by the terminal operating system, the lock pin disassembling and assembling operation is continued; on the contrary, an error is reported; the type of the lock pins is manually confirmed through the HMI touch screen; the confirmed type of the lock pins is fed back to the terminal operating system and the guiding system for information update; and then the lock pin disassembling and assembling operation is continued.

Preferably, in the guiding process:
in the guiding process of a type of lock pins, as the quantity of said type of lock pins that need to be disassembled and assembled changes, the guiding system makes an update according to the information transmitted by the terminal operating system, performs compared calculation on the quantity of said type of lock pins again with the current quantity of said type of lock pins in the stacked storage unit, updates the source and destination of said type of lock pins, and then continues to perform the guiding process; and/or
when a transfer or temporary storage container appears at a terminal, at the end of a guiding process of a type of lock pins, the stacked storage unit also stores said type of lock pins, and then said type of lock pins in the stacked storage unit need to be emptied and restored to an initialized state.

The control system and method for guiding classified storage and feeding/discharging takeout and placement of lock pins provided by the present invention have the beneficial effects:
1, according to the control system and method for guiding classified storage and feeding/discharging takeout and placement of lock pins provided by the present invention, through the double confirmation for the types and the quantity of the lock pins, the destination of disassembling the lock pins and the source of assembling the lock pins are adjusted in real time, and rapid response and accurate control are achieved, thereby increasing an automation rate of a container lock pin disassembling and assembling platform; and
2, according to the control system and method for guiding classified storage and feeding/discharging takeout and placement of lock pins provided by the present invention, the visual recognition device is configured on an end shaft of the robot system to perform photo recognition, the PC host is configured to interact information with the terminal operating system, the HMI touch screen is configured to perform local control and feedback of real-time storage of the lock pins, and the servo crane is configured to perform classified storage of the lock pins or calculate and determine the quantity and types of pre-disassembled and pre-assembled lock pins in combination with the control for the feeding/discharging device to perform an interaction operation and the PLC controller, record the types and quantity of lock pins in the stacked storage unit and allocate storage positions, thereby achieving high overall reliability, optimizing the guiding strategy and greatly increasing an automation rate of the container lock pin disassembling and assembling platform.

### BRIEF DESCRIPTION OF THE DRAWINGS

After reading the detailed description of the non-restrictive embodiments with reference to the following accompanying drawings, other features, objects and advantages of the present invention will become more apparent:

FIG. 1 is a control schematic diagram of a control system for guiding classified storage and feeding/discharging takeout and placement of lock pins of the present invention; and

FIG. 2 is a mechanical arrangement diagram of the control system for guiding classified storage and feeding/discharging takeout and placement of lock pins of the present invention, wherein (a) is a front view, (b) is a left view, and (c) is a top view.

Reference symbols represent the following components: 1—terminal operating system; 2—PC host; 3—PLC controller; 4—transportation device; 5—robot system; 6—stacked storage unit; 7—servo crane; 8—feeding/discharging device; 9—HMI touch screen; 10—visual recognition device; 11—container; and 12—electric control cabinet.

### DETAILED DESCRIPTION OF THE INVENTION

In order to better understand the above technical solution of the present invention, the technical solution of the present invention will be further described below in conjunction with the embodiments.

In a terminal transportation process, in order to ensure the safety of transportation, a container 11 needs to be equipped with a lock pin when a ship is loaded, and the lock pin needs to be disassembled from the container 11 when the ship is unloaded. However, in the operation process of a lock pin disassembling and assembling platform, the lock pin needs to be switched frequently between a disassembled mode and an assembled mode. For example, the disassembled lock pin is thrown away directly by a feeding/discharging device 8 or stored for subsequent assembly of the lock pin, or a lock pin of a corresponding type is supplemented by the feeding/discharging device 8. In the above process, it is necessary to effectively guide the lock pin in the operation process in order to increase the automation rate of the lock pin disassembling and assembling platform.

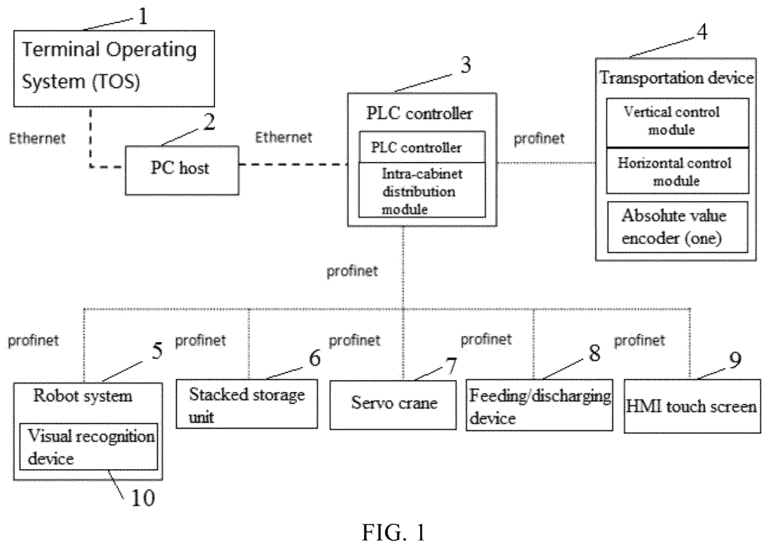

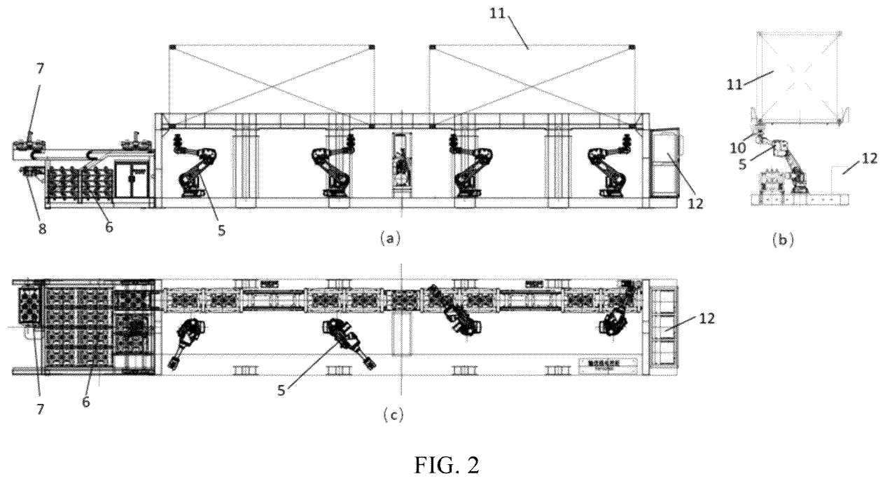

As shown in FIG. 1, and (a), (b) and (c) in FIG. 2, a control system for guiding classified storage and feeding/discharging takeout and placement of lock pins includes a terminal operating system 1 (TOS), a guiding system, a robot system 5, a feeding/discharging device 8, a transportation unit and a stacked storage unit 6. The terminal operating system 1 is configured to acquire terminal operation information in real time, and transmit information of containers 11 (e.g., types and quantity of the containers 11) that need to be unloaded and loaded and corresponding lock pin information (types and quantity of lock pins) to the guiding system; and the guiding system is configured to make a guiding process for a source and a destination of lock pins according to the information transmitted by the terminal operating system 1, and control the robot system 5, the feeding/discharging device 8, the transportation unit and the stacked storage unit 6 to perform operations for disassembly and assembly, classified storage and feeding/discharging takeout and placement of the lock pins. Through the cooperation of various parts, according to the control system for guiding classified storage and feeding/discharging takeout and placement of lock pins provided by the present invention, the destination of disassembling the lock pins and the source of pre-assembling the lock pins are adjusted in real time, and rapid response and accurate control are achieved, thereby increasing an automation rate of the container lock pin disassembling and assembling platform.

As shown in FIG. 1, the guiding system includes a PC host 2 and a PLC controller 3. The PC host 2 is configured to receive information transmitted by the terminal operating system 1, perform classified calculation on the lock pins that need to be disassembled and assembled, then make a guiding judgment on the source of assembling the lock pins and the destination of disassembling the lock pins, and transmit a guiding judgment result to the PLC controller 3. The PLC controller 3 is configured to control the robot system 5 to disassemble and assemble the lock pins according to the information transmitted by the PC host 2, and transport the disassembled lock pins to the stacked storage unit 6 by using the transportation unit for classified storage, or control the feeding/discharging device 8 to perform a feeding/discharging takeout and placement operation of the lock pins.

As shown in FIG. 1, and (a), (b) and (c) in FIG. 2, the transportation unit includes a transportation device 4 and a servo crane 7. The transportation device 4 is configured to transport the lock pins disassembled by the robot system 5 to an exchange area of the stacked storage unit 6. The PLC controller 3 calculates a position of the transportation device 4 by relying on an absolute value encoder built in the transportation device 4, and a vertical control module and a horizontal control module to control the movement of the transportation device 4. The servo crane 7 is configured to perform classified storage on the lock pins in the exchange area or perform the feeding/discharging takeout and placement operation through the feeding/discharging device 8.

As shown in FIG. 1, and (a), (b) and (c) in FIG. 2, in a specific embodiment, the control system for guiding classified storage and feeding/discharging takeout and placement of lock pins further includes a visual recognition device 10 and an HMI touch screen 9. The visual recognition device 10 is installed on an end shaft of the robot system 5 to perform photo recognition on the lock pins. In a further preferred scheme, the visual recognition device 10 is a binocular vision camera; the HMI touch screen 9 is configured to perform a manual operation; and when lock pin information recognized by the visual recognition device 10 is inconsistent with lock pin information provided by the terminal operating system 1, a lock pin type is manually confirmed through the HMI touch screen 9, and the HMI touch screen 9 feeds the result back to the terminal operating system 1 and the guiding system. Through double confirmation for the types and the quantity of the lock pins, the reliability is more high and a guiding strategy is further optimized, thereby greatly increasing the automation rate of the container lock pin disassembling and assembling platform.

As shown in (a), (b) and (c) in FIG. 2, the stacked storage unit 6 may be divided into a plurality of stacking areas through the PLC controller 3, and is configured to store lock pins of the same type in the same stacking area, such that the PC host 2 may count the quantity and storage positions of the lock pins of the same type, thereby better guiding classified storage and feeding/discharging takeout and placement operations of the lock pins.

As shown in FIG. 1, in the control system for guiding classified storage and feeding/discharging takeout and placement of lock pins, the communication among the terminal operating system 1, the guiding system, the robot system 5, the feeding/discharging device 8, the transportation unit and the stacked storage unit 6 is connected in a bus form, such as Ethernet and Profinet. As shown in (a), (b) and (c) in FIG. 2, a switch, a protection electric appliance, auxiliary equipment and others of the control system for guiding classified storage and feeding/discharging takeout and placement of the lock pins are provided in an electric control cabinet 12.

As shown in FIG. 1, and (a), (b) and (c) in FIG. 2, the present invention further provides a control method for guiding classified storage and feeding/discharging takeout and placement of lock pins, in which the control system for guiding classified storage and feeding/discharging takeout and placement of lock pins is used. The control method includes the following steps: starting a lock pin disassembling and assembling platform, and then establishing a communication between the terminal operating system 1 and the guiding system, wherein the terminal operating system 1 is configured to transmit information of containers 11 that need to be unloaded and loaded in the current operation and corresponding lock pin information to the guiding system; and performing classified calculation on the pin locks by the guiding system, judging a source and a destination of each type of lock pins and making a guiding process, wherein the guiding system is configured to control the robot system 5, the feeding/discharging device 8, the transportation unit and the stacked storage unit 6 to perform operations for disassembly and assembly, classified storage and feeding/discharging takeout and placement of the lock pins.

A specific process of the control method for guiding classified storage and feeding/discharging takeout and placement of lock pins provided by the present invention is as follows.

(1) After the lock pin disassembling and assembling platform is started, the control system for guiding classified storage and feeding/discharging takeout and placement of lock pins enters an initialized state. At this moment, the lock pin disassembling and assembling platform is in a lock disassembling mode for the first time, a tray on which the lock pins are placed on each station is not equipped with a lock pin, and there is also no lock pin in the tray of the stacked storage unit 6 (after each operation, if the stacked storage unit 6 still has the unused lock pin, the control system for guiding classified storage and feeding/discharging takeout and placement of lock pins may also empty the stacked storage unit 6 by an equipment emptying mode). After the terminal operating system 1 establishes a communication with the guiding system (the PC host 2), the control system for guiding classified storage and feeding/discharging takeout and placement of lock pins is in a standby preparation state. Then, the terminal operating system 1 sends information such as the sizes and quantity of the containers 11 that need to be unloaded and loaded in the current operation on the ship and the corresponding lock pin type to the guiding system (the PC host 2).

(2) A classified classification procedure of the guiding system for the lock pins is as follows: the PC host 2 classifies the lock pins according to the information transmitted by the terminal operating system 1 (for example, the lock pins that can be used universally are listed as a category, and the lock pins that cannot be used universally are divided into three categories), and counts the quantity of each type of lock pins that need to be disassembled and assembled (the quantity of each type of the containers 11 that need to be loaded and unloaded and the corresponding quantity of the lock pins are counted, and then subjected to classified calculation depending on the type). According to a principle that the lock pins in in the stacked storage unit 6 at the end of the lock pin disassembling and assembling platform operation are guaranteed to be emptied as much as possible to avoid ship locking and other situations, the quantity of each type of lock pins that need to be disassembled and assembled and a dynamic quantity of this type of lock pins stored in the stacked storage unit 6 are subjected to classified calculation, a guiding judgment is finally made for the source of assembling each type of lock pins and the destination of disassembling the lock pins (in the guiding process of each type of lock pins, how many lock pins need to be stored and how many lock pins need to be transferred to the feeding/discharging device 8 for processing should be known, and under normal circumstances, at the end of the lock disassembling and assembling process, the quantity of this type of lock pins in the stacked storage area is zero), and a guiding judgment result is then transmitted to the PLC controller 3.

### (3) Guiding Process Procedure

3.1 A lock pin disassembling and assembling operation, wherein the PLC controller 3 controls the robot system 5 to disassemble and assemble the lock pins that need to be disassembled and assembled according to the guiding judgment result, and transfers the disassembled lock pins to the transportation device 4.

3.2 Classified storage of lock pins, wherein the PLC controller 3 transfers the disassembled lock pins to an exchange area of the stacked storage unit 6 by using the transportation device 4, and controls the servo crane 7 to perform the classified storage on the lock pins in the exchange area according to the guiding judgment result. In the storage process, the PLC controller 3 may perform planning according to a situation of the stacked storage unit 6, store the same type of lock pins in a certain stacking area, perform accumulative or degressive counting, and record an internal storage state (type, quantity and position of the lock pins) of the stacked storage unit 6 in combination with the limitation for area layers of the stacked storage unit 6, for the guiding system to perform a calculation.

3.3 A feeding/discharging takeout and placement operation, wherein the PLC controller 3 guides the servo crane 7 to transfer the disassembled lock pins or the lock pins in the exchange area to the feeding/discharging device 8 according to the guiding judgment result, for the feeding/discharging takeout and placement operation.

3.4 Type recognition of lock pins, wherein in the actual operation of a terminal, the lock pin information provided by the terminal operating system 1 may be deviated, so the visual recognition device 10 is used to recognize a type of the lock pins in the process of the lock pin disassembling and assembling operation. The PLC controller 3 controls the visual recognition device 10 on the robot system 5 to perform photo recognition on the lock pins. When the type of the lock pins recognized by the visual recognition device 10 is consistent with lock pin information transmitted by the terminal operating system 1, the lock pin disassembling and assembling operation is continued. On the contrary, an error is reported. The type of the lock pins is manually confirmed through the HMI touch screen 9. The confirmed type of the lock pins is fed back to the terminal operating system 1 and the guiding system for information update; and then the lock pin disassembling and assembling operation is continued.

3.5 In the guiding process: in the guiding process of a type of lock pins, as the quantity of this type of lock pins that need to be disassembled and assembled changes, the guiding system (the PC host 2) may make an update according to the information transmitted by the terminal operating system 1, perform compared calculation on the quantity of this type of lock pins again with the current quantity of this type of lock pins in the stacked storage unit 6, update the source and destination of this type of lock pins, and then continue to perform the guiding process; and when a transfer or temporary storage container 11 appears at a terminal, at the end of a guiding process of a type of lock pins, the stacked storage unit 6 also stores this type of lock pins, and then this type of lock pins in the stacked storage unit 6 need to be emptied and restored to an initialized state.

Through the above-mentioned process, the servo crane 7 repeatedly performs the classified storage and feeding/discharging takeout and placement operations of the lock pins under the guidance of the PLC controller 3.

A person of ordinary skill in the art should realize that the above embodiments are only used to illustrate the present invention, and are not used as a limitation of the present invention, as long as the changes and variants of the above embodiments within the scope of the essential spirit of the present invention fall within the scope of the claims of the present invention.

1: A control system for guiding classified storage and feeding/discharging takeout and placement of lock pins, comprising:
a terminal operating system, a guiding system, a robot system, a feeding/discharging device, a transportation unit, and a stacked storage unit, wherein
the terminal operating system is configured to acquire terminal operation information in real time and transmit information of containers that need to be unloaded and loaded and corresponding lock pin information to the guiding system; and
the guiding system is configured to guide a source and a destination of lock pins according to the information transmitted by the terminal operating system, and control the robot system, the feeding/discharging device, the transportation unit and the stacked storage unit to perform operations for disassembly and assembly, classified storage and feeding/discharging takeout and placement of the lock pins.

2: The control system for guiding classified storage and feeding/discharging takeout and placement of lock pins according to claim 1, wherein the guiding system comprises a PC host and a PLC controller; the PC host is configured to receive the information transmitted by the terminal operating system, perform classified calculation on the lock pins that need to be disassembled and assembled, then make a guiding judgment on the source of assembling the lock pins and the destination of disassembling the lock pins, and transmit a guiding judgment result to the PLC controller; and the PLC controller is configured to control the robot system to disassemble and assemble the lock pins according to the information transmitted by the PC host, and transport the disassembled lock pins to the stacked storage unit by using the transportation unit for classified storage, or control the feeding/discharging device to perform a feeding/discharging takeout and placement operation for the lock pins.

3: The control system for guiding classified storage and feeding/discharging takeout and placement of lock pins according to claim 1, wherein the transportation unit comprises a transportation device and a servo crane; the transportation device is configured to transport the lock pins disassembled by the robot system to an exchange area of the stacked storage unit; and the servo crane is configured to perform classified storage on the switched lock pins or perform the feeding/discharging takeout and placement operation through the feeding/discharging device.

4: The control system for guiding classified storage and feeding/discharging takeout and placement of lock pins according to claim 1, wherein the control system for guiding classified storage and feeding/discharging takeout and placement of lock pins further comprises a visual recognition device and an HMI touch screen; the visual recognition device is installed on an end shaft of the robot system to perform photo recognition on the lock pins; the HMI touch screen is configured to perform a manual operation; and when lock pin information recognized by the visual recognition device is inconsistent with lock pin information provided by the terminal operating system, a lock pin type is manually confirmed through the HMI touch screen, and the HMI touch screen feeds the result back to the terminal operating system and the guiding system.

5: The control system for guiding classified storage and feeding/discharging takeout and placement of lock pins according to claim 4, wherein the visual recognition device is a binocular vision camera.

6: A control method for guiding classified storage and feeding/discharging takeout and placement of lock pins, which adopts the control system according to claim 1, and comprises the following steps:
starting a lock pin disassembling and assembling platform, and then establishing a communication between the terminal operating system and the guiding system, wherein the terminal operating system is configured to transmit information of containers that need to be unloaded and loaded in the current operation and corresponding lock pin information to the guiding system; and
performing classified calculation on the pin locks by the guiding system, judging a source and a destination of each type of lock pins and making a guiding process, wherein the guiding system is configured to control the robot system, the feeding/discharging device, the transportation unit and the stacked storage unit to perform operations for disassembly and assembly, classified storage and feeding/discharging takeout and placement of the lock pins.

7: The control method for guiding classified storage and feeding/discharging takeout and placement of lock pins according to claim 6, wherein a classified calculation procedure performed by the guiding system for the pin locks is as follows: the PC host classifies the lock pins according to the information transmitted by the terminal operating system, counts the quantity of each type of lock pins that need to be disassembled and assembled, then perform compared calculation on the quantity of each type of lock pins that need to be disassembled and assembled and a dynamic quantity of said type of lock pins stored in the stacked storage unit, and finally makes a guiding judgment on the source of assembling each type of lock pins and the destination of disassembling the lock pins, and transmit a guiding judgment result to the PLC controller.

8: The control method for guiding classified storage and feeding/discharging takeout and placement of lock pins according to claim 7, wherein the guiding procedure is as follows:
a lock pin disassembling and assembling operation, wherein the PLC controller controls the robot system to disassemble and assemble the lock pins that need to be disassembled and assembled, and transfers the disassembled lock pins to the transportation device:
classified storage of the lock pins, wherein the PLC controller transfers the disassembled lock pins to an exchange area of the stacked storage unit by using the transportation device, and controls the servo crane to perform classified storage on the lock pins in the exchange area; and
a feeding/discharging takeout and placement operation, wherein the PLC controller guides the servo crane to transfer the disassembled lock pins or the lock pins in the exchange area to the feeding/discharging device for the feeding/discharging takeout and placement operation.

9: The control method for guiding classified storage and feeding/discharging takeout and placement of lock pins according to claim 8, wherein the guiding process further comprises recognizing types of the lock pins;
a procedure of recognizing the types of the lock pins is as follows: in the process of the lock pin disassembling and assembling operation, the PLC controller controls the visual recognition device on the robot system to perform photo recognition on the lock pins; when the type of the lock pins recognized by the visual recognition device is consistent with lock pin information transmitted by the terminal operating system, the lock pin disassembling and assembling operation is continued: on the contrary, an error is reported; the type of the lock pins is manually confirmed through the HMI touch screen; the confirmed type of the lock pins is fed back to the terminal operating system and the guiding system for information update; and then the lock pin disassembling and assembling operation is continued.

10: The control method for guiding classified storage and feeding/discharging takeout and placement of lock pins according to claim 8, wherein in the guiding process:
in the guiding process of a type of lock pins, as the quantity of said type of lock pins that need to be disassembled and assembled changes, the guiding system makes an update according to the information transmitted by the terminal operating system, performs compared calculation on the quantity of said type of lock pins again with the current quantity of said type of lock pins in the stacked storage unit, updates the source and destination of said type of lock pins, and then continues to perform the guiding process; and/or
when a transfer or temporary storage container appears at a terminal, at the end of a guiding process of a type of lock pins, the stacked storage unit also stores said type of lock pins, and then said type of lock pins in the stacked storage unit need to be emptied and restored to an initialized state.
